(19) United States
(12) Patent Application Publication
(10) Pub. No.: US 2006/0082541 A1
(43) Pub. Date: Apr. 20, 2006

(54) INPUT DETECTION DEVICE AND RELATED METHOD

(76) Inventors: Chang-Yuan Wu, Taipei City (TW); Li-Min Tseng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/711,995

(22) Filed: Oct. 19, 2004

(51) Int. Cl. G09G 5/00

(52) U.S. Cl. 345/156

(57) ABSTRACT

An input detection device contains a button set having a plurality of buttons utilized for inputting commands, each button outputting a unique voltage level when the button is activated. The input detection device also contains a voltage generating circuit for outputting a plurality of generated voltage levels corresponding to the unique voltage levels outputted by each of the buttons in the button set, and a comparator for comparing each of the generated voltage levels outputted from the voltage generating circuit with the voltage outputted from the button set. A control circuit controls the voltage generating circuit to alternately output each of the generated voltage levels, records the generated voltage level that is approximately equal to the voltage outputted from the button set, and determines which button in the button set was activated based on the recorded generated voltage level.

### BACKGROUND OF INVENTION

1. Field of the Invention

The present invention relates to an input device having plurality of buttons, and more specifically to a detection device and related method for determining which button of the plurality of buttons was activated.

2. Description of the Prior Art

Due to package size limitations, in an application-specific integrated circuit (ASIC), the number of general purpose input/output (GPIO) pins available for performing dedicated tasks is always limited. The designers of ASICs constantly try to simplify their design to cut costs whenever possible.

Unfortunately, when a plurality of push buttons (or switches) is used to provide input to an ASIC, the number of GPIO pins required to monitor the status of the buttons is equal to the number of buttons used. For instance, if a total of eight buttons are utilized to provide input to an ASIC, the ASIC will require eight GPIO pins for receiving input from the buttons. As the number of push buttons increases, it is easy to see the great burden placed on the designers of the ASIC to accommodate the large number of GPIO pins.

### SUMMARY OF INVENTION

It is therefore an objective of the claimed invention to provide a method for detecting manual input by using fewer I/O pins in order to solve the above-mentioned problems.

According to the claimed invention, an input detection device contains a button set having a plurality of buttons utilized for inputting commands, each button outputting a unique voltage level when the button is activated. The input detection device also contains a voltage generating circuit capable of outputting a plurality of generated voltage levels corresponding to the unique voltage levels outputted by each of the buttons in the button set, a plurality of input/output (I/O pins) for specifying which generated voltage level is output by the voltage generating circuit, and a comparator for comparing each of the generated voltage levels outputted from the voltage generating circuit with the voltage outputted from the button set. A control circuit is utilized for controlling the voltage generating circuit with the plurality of I/O pins to alternately output each of the generated voltage levels, for recording the generated voltage level that is approximately equal to the voltage outputted from the button set, and for determining which button in the button set was activated based on the recorded generated voltage level.

It is an advantage of the claimed invention that the control circuit alternately outputs each of the generated voltage levels by utilizing the plurality of I/O pins for determining which button was activated while using a smaller required number of I/O pins than was used in the prior art.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a functional block diagram of an input detection device according to the present invention.

FIG. 2 is a circuit diagram of a button set circuit.

FIG. 3 is a table showing voltage values added to a first reference voltage when one of the eight buttons in the button set circuit is pressed.

FIG. 4 is a circuit diagram of a voltage generating circuit.

FIG. 5 is a table showing voltage values of a second reference voltage generated by the voltage generating circuit.

FIG. 6 is a table illustrating the detection of pressed buttons according to the present invention.

### DETAILED DESCRIPTION

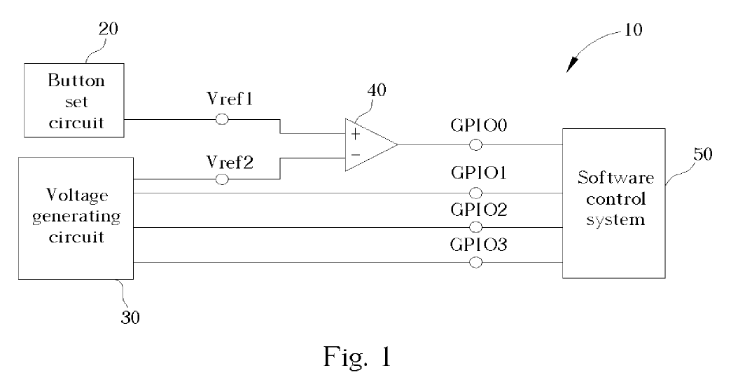

Please refer to FIG. 1. FIG. 1 is a functional block diagram of an input detection device 10 according to the present invention. The input detection device 10 is used to reduce the number of I/O pins needed in a circuit such as an ASIC. The input detection device 10 contains a button set circuit 20 having a plurality of push buttons or switches. When pressed or activated, circuitry connected to each button outputs a unique voltage level. A total voltage value is summed by the button set circuit 20, and is output as a first reference voltage Vref1.

The input detection device 10 also contains a voltage generating circuit 30 for generating a plurality of generated voltage levels corresponding to the unique voltage levels outputted by each of the buttons in the button set circuit 20. The generated voltage level currently being output by the voltage generating circuit 30 is labeled as a second reference voltage Vref2.

A comparator 40 is used to compare the first reference voltage Vref1 output from the button set circuit 20 with the second reference voltage Vref2 output from the voltage generating circuit 30. The result, outputted through GPIO pin GPIO0, is sent to a software control system 50. The software control system 50 then determines exactly which button in the button set circuit 20 was activated. A detailed overview of the input detection device 10 will be given below.

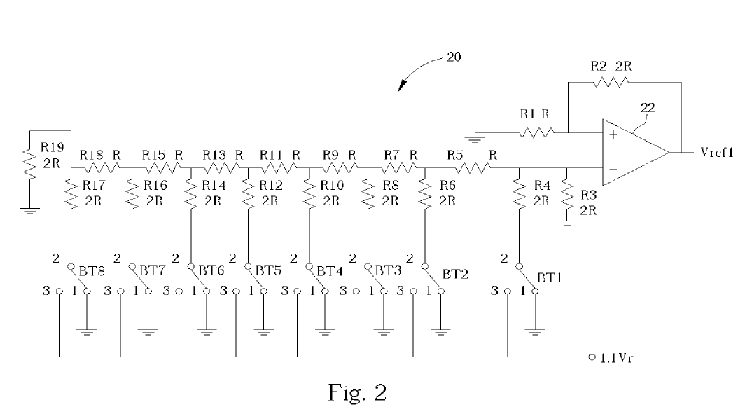

Please refer to FIG. 2. FIG. 2 is a circuit diagram of the button set circuit 20. The button set circuit 20 contains a plurality of buttons BT1-BT8. Each button is represented as a switch containing nodes 1, 2, and 3. Node 1 is connected to ground, while node 3 is connected to a voltage source of 1.1Vr (a constant 1.1 multiplied by a reference voltage Vr). Please note that this value of 1.1Vr is used as an example, and other voltage values can also be used with the present invention. For each button, when the button is not activated (or not pressed), nodes 1 and 2 are connected for connecting node 2 to ground. When the button is activated (or pressed during use), nodes 2 and 3 are connected for connecting node 2 to the voltage source 1.1 Vr. As shown in FIG. 2, each of the buttons BT1-BT8 is connected in series to a resistor having a resistance of 2R (i.e. R4, R6, R8 . . . ). The buttons BT1-BT8 are connected together in a chain-like circuit connection. There is a resistor with resistance of R (i.e. R5, R7, R9 . . . ) connected between each two successive buttons. While other resistance values can be used with the present invention, the resistance values shown in FIG. 2 are chosen to illustrate the preferred 2:1 ratio of resistors having resistances of 2R and R. The chain of buttons BT1-BT8 and resistors R3-R19 is connected to a positive input of an op-amp 22. A resistor R1 is connected between a negative input of the op-amp 22 and ground, and a resistor R2 is connected between the positive input of the op-amp 22 and an output of the op-amp 22. The output of the op-amp 22 is the first reference voltage Vref1, which is the output of the button set circuit 20.

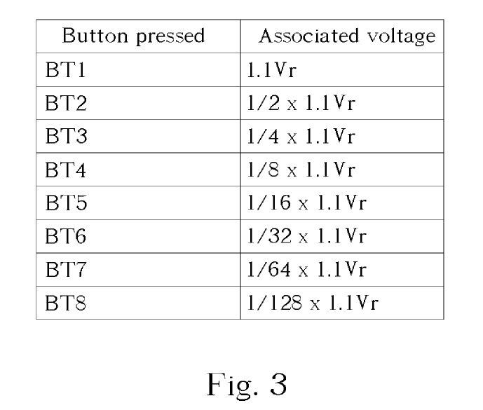

Please refer to FIG. 3 with reference to FIG. 2. FIG. 3 is a table showing voltage values added to the first reference voltage Vref1 when one of the eight buttons in the button set circuit 20 is pressed. Since the voltage source provides a voltage of 1.1 Vr, all voltage values in FIG. 3 are a fraction of 1.1 Vr. When no buttons are pressed, the first reference voltage Vref1 will have a voltage value of 0 V. When only button BT1 is pressed, the first reference voltage Vref1 will have a voltage value of 1.1 Vr. When only button BT2 is pressed, the first reference voltage Vref1 will have a voltage value of ½*1.1Vr. Each successive button has an associated voltage value that is one half of the voltage value of the preceding button. Thus, button BT8 has an associated voltage value of 1/128*1.1 Vr. The factor of two, which preceding voltage values are divided by to compute succeeding voltage values, is used as an example only. Other factors may also be used, such as a factor of three or four, but the factor of two is preferred.

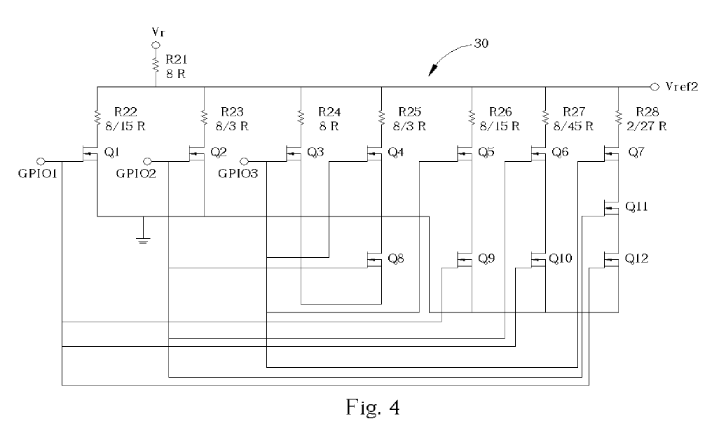

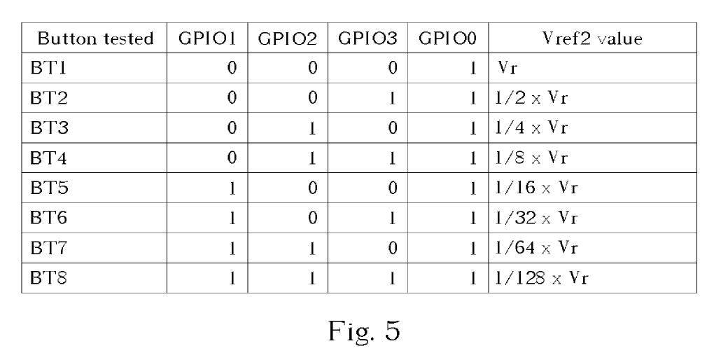

Please refer to FIG. 4. FIG. 4 is a circuit diagram of the voltage generating circuit 30. The voltage generating circuit 30 contains three GPIO pins GPIO1, GPIO2, and GPIO3 that are used to control the second reference voltage Vref2 that the voltage generating circuit 30 generates. The three GPIO pins GPIO1, GPIO2, and GPIO3 are controlled by the software control system 50 to turn on and off, i.e., supply high voltage when that pin is given a value “1”, or low voltage when that pin is given a value “0”. When individual pins or combinations of the three GPIO pins GPIO1, GPIO2, and GPIO3 are given a value of “1”, various combinations of a plurality of transistors Q1-Q12 are controlled to conduct current. The voltage generating circuit 30 works as a voltage dividing circuit based on resistor R21 and a combination of resistors R22-R28. The second reference voltage Vref2 is equal to the source voltage Vr multiplied by a fraction determined by the values of the three GPIO pins GPIO1, GPIO2, and GPIO3. Please refer to FIG. 5 with reference to FIG. 4. FIG. 5 is a table showing voltage values of the second reference voltage Vref2 generated by the voltage generating circuit 30. When none of the three GPIO pins GPIO1, GPIO2, and GPIO3 is given a value of “1”, the second reference voltage Vref2 is equal to Vr. When only pin GPIO3 is given a value of “1”, the second reference voltage Vref2 is equal to ½*Vr. Succeeding values of the second reference voltage Vref2 are decreased by a factor of two using various combinations of the three GPIO pins GPIO1, GPIO2, and GPIO3. When all of the three GPIO pins GPIO1, GPIO2, and GPIO3 is given a value of “1”, the second reference voltage Vref2 is equal to 1/128*Vr.

Please refer back to FIG. 1, FIG. 3, and FIG. 5. When one of the buttons BT1-BT8 in the button set circuit 20 is pressed, the associated voltage outputted as the first reference voltage Vref1 is shown in FIG. 3. The first reference voltage Vref1 is a fraction (ranging from 1 to 1/128) of 1.1Vr. On the other hand, when the software control system 50 controls the voltage generating circuit 30 to generate different voltages, the voltages are outputted from the voltage generating circuit 30 as the second reference voltage Vref2 as shown in FIG. 5. The second reference voltage Vref2 is a fraction (ranging from 1 to 1/128) of Vr. The software control system 50 continuously performs software polling to alternately output the different values of the second reference voltage Vref2 shown in FIG. 5 sequentially by controlling the values sent to the voltage generating circuit 30 on the three GPIO pins GPIO1, GPIO2, and GPIO3.

Both the first reference voltage Vref1 and the second reference voltage Vref2 are then compared by the comparator 40 shown in FIG. 1. When the comparator 40 determines that the first reference voltage Vref1 is greater than the second reference voltage Vref2, the comparator 40 outputs a value of “1” through the pin GPIO0. The software control system 50 continues to control the voltage generating circuit 30 to alternately output various voltage values sequentially as the second reference voltage Vref2. While this is happening, the software control system 50 monitors the GPIO pin GPIO0 to keep track of which values of the second reference voltage Vref2 are less than the first reference voltage Vref1. The software control system 50 then determines the highest value of the second reference voltage Vref2 output by the voltage generating circuit 30 that is lower than the first reference voltage Vref1. Once this information is determined, the software control system 50 then knows which button BT1-BT8 of the button set circuit 20 was pressed. For example, if BT3 is pressed, then it will output Vref1=¼×1.1Vr, and the comparator 40 will output value “1” for all GPIO1-GPIO3 combinations generating Vref2 equal or lower than ¼Vr. However, the (GPIO1,GPIO2,GPIO3)=(0,1,0) combination provides the highest value of Vref2 output by the voltage generating circuit 30 which is lower than the Vref1, so the button BT3 is detected.

On the other hand, as a second embodiment, please note that if the voltage value of the voltage source of the button set circuit 20 (i.e. 1 Vr) was lower than the voltage value of the voltage source of the voltage generating circuit 30 (i.e. 1.1Vr), the software control system 50 would instead determine the lowest value of the second reference voltage Vref2 output by the voltage generating circuit 30 that is higher than the first reference voltage Vref1 for determining which button BT1-BT8 of the button set circuit 20 was pressed.

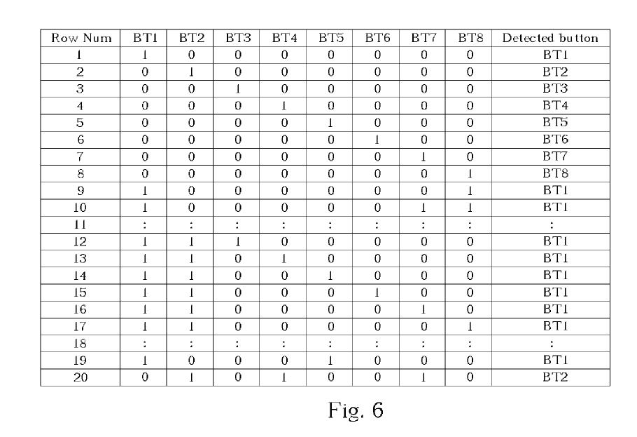

It is also possible for more than one button BT1-BT8 of the button set circuit 20 to be pressed at a time. Whenever a button in the button set circuit 20 is pressed, the value of the first reference voltage Vref1 is increased by the associated voltage amount shown in FIG. 3. For instance, if buttons BT2 and BT3 are pressed at the same time, the first reference voltage Vref1 would have a value of (½*1.1 Vr)+(¼*1.1Vr), for a total of ¾*1.1Vr. This total is between the values of ½*Vr and Vr that are shown in FIG. 5. Therefore, the software control system 50 would determine that the button BT2 was pressed. Therefore, even though the button BT3 was also pressed, the software control system 50 does not detect it since the button BT2 has higher priority. Priority is ranked according to the voltage value associated with each button, as shown in FIG. 3. Therefore, BT1 has the highest priority and BT8 has the lowest priority. If too many buttons are pressed at the same time, it is possible that the software control system 50 may incorrectly determine which button having the highest priority was pressed. For this reason, the input detection device 10 of the present invention preferably allows up to two or three buttons to be pressed at the same time. If parameters of the input detection device 10 are changed, such as the constant 1.1 that the voltage source 1.1 Vr is multiplied by, then more buttons may also be pressed at once. No matter how many buttons are pressed at the same time, the software control system 50 will only detect that the button having the highest priority out of the buttons pressed was actually pressed. This feature is summarized in FIG. 6, which is a table illustrating the detection of pressed buttons according to the present invention. As shown in rows 1-8 of FIG. 6, when only one button is pressed, the software control system 50 determines the correct button. As shown in row 10, when buttons BT1, BT7, and BT8 are pressed simultaneously, the software control system 50 detects that button BT1 was pressed since it has the highest priority out of the buttons BT1, BT7, and BT8. Likewise, as shown in row 20, when buttons BT2 and BT7 are pressed simultaneously, the software control system 50 detects that button BT2 was pressed.

In summary, through the use of the software control system 50 to control the voltage generating circuit 30 to alternately generate various voltages corresponding to the voltages generated by the buttons of the button set circuit 20, the input detection device 10 requires a significantly smaller amount of GPIO pins to be used for detection. Only n+1 GPIO pins are required in the present invention input detection device 10 for detecting which button out of 2ˆn buttons was pressed, where n is a positive integer. This offers a significant savings in GPIO pins compared to the prior art, in which n GPIO pins were required for n buttons. The present invention input detection device 10 and related method is therefore ideally suited for implementation in an ASIC or other circuits that have a limited number of inputs available.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An input detection device, comprising:
a button set circuit comprising a plurality of buttons utilized for inputting commands, each button outputting a unique voltage level when the button is activated;
a voltage generating circuit capable of outputting a plurality of generated voltage levels corresponding to the unique voltage levels outputted by each of the buttons in the button set circuit;
a plurality of input/output (I/O pins) for specifying which generated voltage level is output by the voltage generating circuit;
a comparator for comparing each of the generated voltage levels outputted from the voltage generating circuit with the voltage outputted from the button set circuit; and
a control circuit for controlling the voltage generating circuit with the plurality of I/O pins to alternately output each of the generated voltage levels, for recording the generated voltage level that is approximately equal to the voltage outputted from the button set circuit, and for determining which button in the button set circuit was activated based on the recorded generated voltage level.

2. The input detection device of claim 1 wherein the control circuit records the highest generated voltage level that is lower than the voltage outputted from the button set circuit.

3. The input detection device of claim 1 wherein the control circuit records the lowest generated voltage level that is higher than the voltage outputted from the button set circuit.

4. The input detection device of claim 1 wherein the I/O pins are general purpose I/O (GPIO) pins.

5. The input detection device of claim 1 wherein the unique voltage level associated with each button is greater than the unique voltage level associated with a preceding button by a factor of two and is less than the unique voltage level associated with a succeeding button by a factor of two.

6. The input detection device of claim 1 wherein when two or three buttons are pressed simultaneously, the input detection device determines that the button having a highest priority was activated.

7. The input detection device of claim 6 wherein the button outputting the largest unique voltage level has the highest priority.

8. The input detection device of claim 1 wherein n+1 I/O pins are capable of detecting which button of up to 2ˆn buttons was activated, n being a positive integer.

9. A method of detecting input commands, comprising:
providing a button set circuit comprising a plurality of buttons utilized for inputting commands, each button outputting a unique voltage level when the button is activated;
activating at least one button in the button set circuit, thereby outputting a voltage from the button set circuit;
outputting a plurality of generated voltage levels corresponding to the unique voltage levels outputted by each of the buttons in the button set circuit;
comparing each of the generated voltage levels with the voltage outputted from the button set circuit;
alternately outputting each of the generated voltage levels;
recording the generated voltage level that is approximately equal to the voltage outputted from the button set circuit; and determining which button in the button set circuit was activated based on the recorded generated voltage level.

10. The method of claim 9 wherein recording the generated voltage level that is approximately equal to the voltage outputted from the button set circuit comprises recording the highest generated voltage level that is lower than the voltage outputted from the button set circuit.

11. The method of claim 9 wherein recording the generated voltage level that is approximately equal to the voltage outputted from the button set circuit comprises recording the lowest generated voltage level that is higher than the voltage outputted from the button set circuit.

12. The method of claim 9 wherein the unique voltage level associated with each button is greater than the unique voltage level associated with a preceding button by a factor of two and is less than the unique voltage level associated with a succeeding button by a factor of two.

13. The method of claim 9 wherein when two or three buttons are pressed simultaneously, determining that the button having a highest priority was activated.

14. The method of claim 13 wherein the button outputting the largest unique voltage level has the highest priority.
